(19) United States
(12) Patent Application Publication
(10) Pub. No.: US 2002/0129059 A1
(43) Pub. Date: Sep. 12, 2002

(54) XML auto map generator

(76) Inventor: Jeffery R. Eck, Poolesville, MD (US)

Correspondence Address: William T. Ellis, FOLEY & LARDNER, Washington Harbour, 3000 K Street, N.W., Suite 500, Washington, DC, 20007-5109, US

(21) Appl. No.: 09/750,287

(22) Filed: Dec. 29, 2000

(51) Int. Cl. G06F 15/00; G06F 17/00; G06F 17/24; G06F 17/21

(52) U.S. Cl. 707/513

(57) ABSTRACT

A method, system and program product for automatically generating an XML map comprising the steps of: receiving an XML environment; creating a target model and a source model in accordance with predetermined rules, with one of the models being an XML model and the other of the models being a flat file or data base model; creating business rules for moving data from a source file to a target file for a plurality of defining items in the source model; creating a run file with file names for generating the map.

### FIELD OF THE INVENTION

The present invention relates generally to the field of document communication between trading partners, and more particularly to the field of automatic document mapping between two or more different formats.

### BACKGROUND OF THE INVENTION

Currently trading partners and other users of XML that wish to exchange document, such as invoices and other trading documents, must manually transform the format of the source document from company A to a different format for a target document for company B. In most cases, the trading partners are converting from their internal applications to XML, as a common means of communications. The receiving trading partner is converting received XML into a format that is compatible with its internal application, which in many cases is a flat file or data base system. Note, for purposes of information, that a flat file is typically read sequentially, while a data base is read by means of a key. Thus, the most common transformation is between XML and flat file or data base. Such operations are time-consuming and costly, and add unacceptable delay into trading operations.

### SUMMARY OF THE INVENTION

Briefly, the present invention solves the foregoing problems by providing a method for automatically generating an XML map comprising the steps of: receiving an XML environment; creating a target model and a source model in accordance with predetermined rules, with one of the models being an XML model and the other of the models being a flat file or data base model; creating business rules for moving data from a source file to a target file for a plurality of defining items in the source model; creating a run file with file names for generating the map.

In a further aspect of the present invention, the step is included of creating test data for each of the plurality of defining items.

In a yet further aspect of the present invention, the test data is created based on the structure of the source model and the properties of the defining elements from the source model.

In a yet further aspect of the present invention, the step is included of creating at least one ID code file from an attribute list in the XML environment.

In a yet further aspect of the present invention, the creating business rules step comprises creating a business rule for all defining items in the source model.

In a yet further aspect of the present invention, the step is included of simultaneously displaying the source model and the target model on a single display.

In a yet further aspect of the present invention, the step is included of moving at least one element in one of the source and target models to a different location within that one model.

In a yet further aspect of the present invention, the moving step comprises drag and dropping the element over a desired location within the one model.

In a yet further aspect of the present invention, the step is included of manually creating a business rule by drag and dropping an element in one of the source and target models to an element in the other of the source and target models.

In a yet further aspect of the present invention, the run file includes a source file, a source model, a target file, a target model, a source access file, and a target access file.

In a yet further aspect of the present invention, the XML environment is one of an XML DTD, and XML schema, and an XML message.

In a yet further aspect of the present invention, the step of providing a user interface to permit the selection of an inbound or an outbound map.

In a yet further aspect of the present invention, the provided user interface permits the addition of specific rules for controlling the transfer of data between a source element and a target element.

In a yet further aspect of the present invention, the created source and target models use substantially the names or elements or defining items of the XML environment.

In a yet further aspect of the present invention, the defining item names are in the same order in the created source and target models immediately after the model creation step.

In a yet further aspect of the present invention, the test data is generated based on information in the source model.

In a yet further aspect of the present invention, the XML message comprises, if the XML environment is an XML DTD or an XML schema, all defining items or elements in the XML DTD or the XML schema.

In a yet further aspect of the present invention, each piece of test data for the defining item or element is created to be consistent with the properties of the defining item and using attributes from an attribute list for that defining item, if such an attribute list is included in the XML DTD or XML schema.

In a yet further aspect of the present invention, the test data for the defining item/element is in the same sequence as defined in the XML environment.

In a yet further aspect of the present invention, the generated test data for defining item is a tag name for the defining element.

In a further embodiment of the present invention, a system is provided for automatically generating an XML map comprising: a first component to receive an XML environment; a second component to create a target model and a source model in accordance with predetermined rules, with one of the models being an XML model and the other of the models being a flat file or data base model; a third component to create business rules for moving data from a source file to a target file for a plurality of defining items in the source model; a fourth component to create a run file with file names for generating the map.

In yet a further embodiment of the present invention, program product is provided for automatically generating an XML map comprising the following machine readable program code: first code for receiving an XML environment; second code for creating a target model and a source model in accordance with predetermined rules, with one of the models being an XML model and the other of the models being a flat file or data base model; third code for creating business rules for moving data from a source file to a target file for a plurality of defining items in the source model; fourth code for creating a run file with file names for generating the map.

### BRIEF DESCRIPTION OF THE DRAWINGS

The accompanying drawings, which are incorporated in and constitute a part of the specification, illustrate a presently preferred embodiment of the invention, and, together with the general description given above and the detailed description of the preferred embodiment given below, serve to explain the principles of the invention.

FIG. 1 is a schematic block diagram showing the high level components of the e-commerce system of the present invention.

FIG. 2 is a block diagram showing the components of a preferred embodiment of the e-commerce data processing system of the present invention.

FIG. 3 is a flowchart of a preferred embodiment of the present invention.

FIG. 4A is a schematic diagram of an XML DTD input FIG. 4B is a schematic diagram of an XML document that follows the DTD.

FIG. 5. is a schematic diagram of dialog box to be presented to the user.

FIG. 6 is a schematic diagram of an example of a generated source model.

FIG. 7 is a schematic diagram of an example of a generated target model.

FIG. 8 is a schematic diagram of a run file.

FIG. 9 is a schematic diagram illustrating the relationship between FIGS. 4A, 5, 6, 7, and 8.

### DETAILED DESCRIPTION OF THE PREFERRED EMBODIMENT

The present invention provides, in a general aspect, a computer implemented method of providing electronic commerce transactions between a plurality of trading partners, each trading partner associated with a data processing system and connected to an e-commerce data processing system. In order to achieve such electronic commerce transactions, an XML to flat file or data base map must be built and tested, or a flat file or data base to XML map (referred to as an “XML” map) must be built and tested. An XML map is a set of definitions of the source structure and the target structure, and includes business rules or logic that govern what elements of information from the source structure are moved to what elements of the target structure and if any manipulation of the data is to be performed on the data elements. A number of items must be formed before an XML map can be built and tested. Further, sample test data must be created before the map and the mapping business rules or logic can be tested.

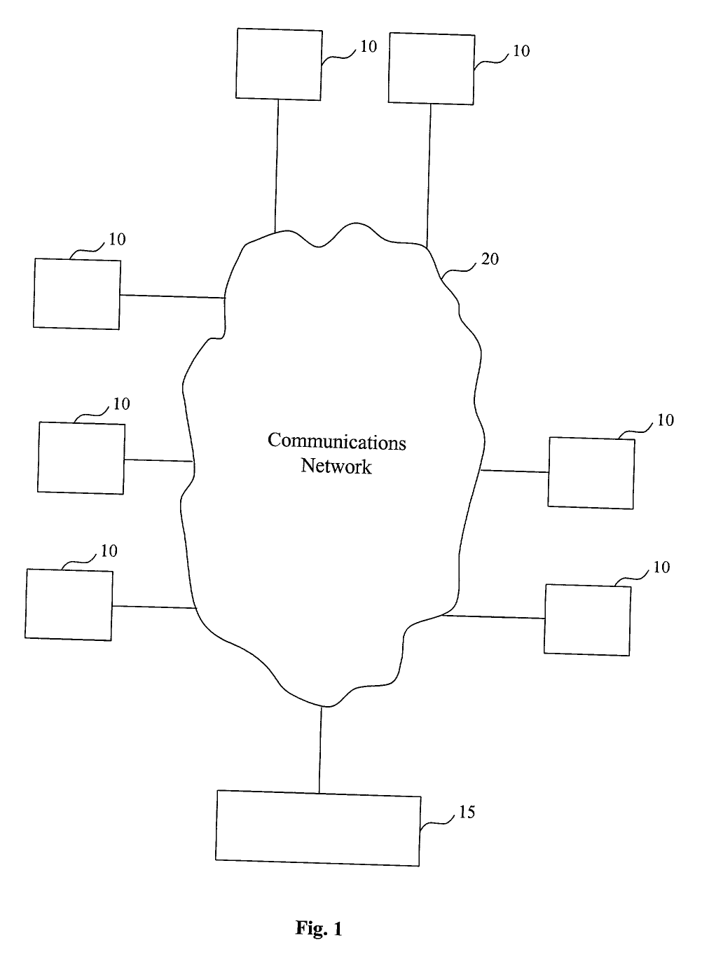

FIG. 1 is a block diagram showing the high level components of a preferred embodiment of the present invention. A plurality of trading partner computer systems 10 are connected through a communication network 20. Each, or a plurality of these trading partner computer systems 10 could include the processing software to be disclosed below. Alternatively, each or a plurality of the trading partner systems could be connected through the communication network 20 to one or more processing systems 15 that contain the processing software to be described below. In the preferred embodiment, the communication network 20 is the Internet. However, the communication network 20 can also include a public tariff telephone network or a private Value Added Network (VAN), such as that provided by Electronic Data Interchange (EDI) service providers, for example, the EDI VAN services provided by General Electric (GE). Alternatively, the communication network can be implemented using any combination of known communication networks.

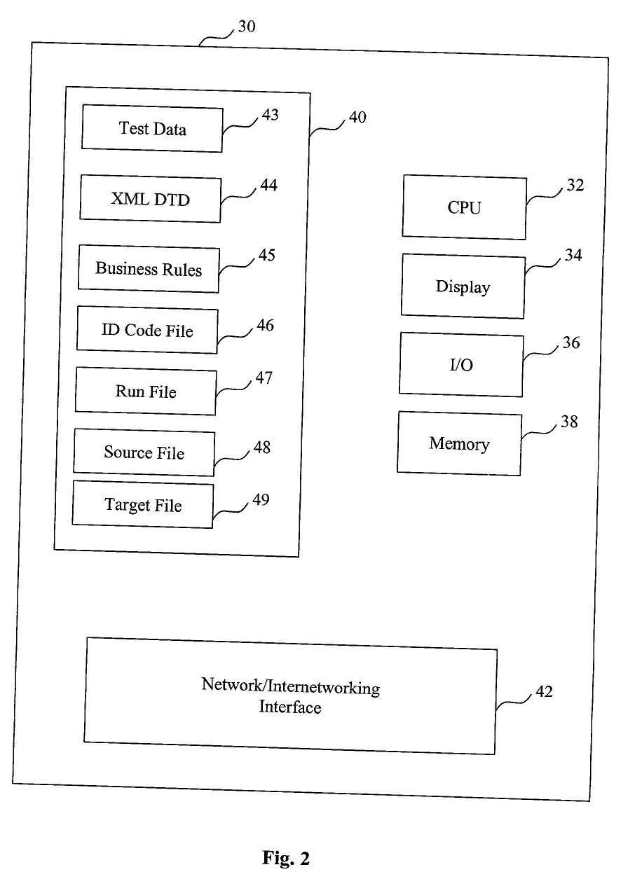

FIG. 2 is block diagram showing one embodiment of the components of the e-commerce data processing system 15 or the configured computer system of one or more of the trading partners. The e-commerce data processing system is implemented as a computer system 30 which includes all the customary components of a computer system including a CPU 32, a display 34, a keyboard or other I/O device 36, RAM or ROM or other memory 38, as well as stable storage devices 40 such as disk and CD-ROM drives, and a network or communications interface 42. It should also be noted that a single CPU based computer system is shown for clarity. One skilled in the art would recognize that the computer e-commerce data processing system 30 could also be implemented using a multi-processor computer system. Alternatively, a distributed computer system could be implemented in which the functionality of the e-commerce data processing system could be provided by several computer systems that are connected over a computer network. It is also possible to distribute the functionality of the e-commerce data processing system over a multitude of sites which are suitably connected together using conventional inter-networking techniques.

It should also be noted that the file 40, in a preferred embodiment, includes a test data file 43, an XML DTD file 44, a business rules file 45, and ID code file 46, a run file 47, a source model file 48, and a target model file 49. Note that these files are logical files containing the data elements. One skilled in the art would recognize that this data could be stored in a suitable database such that all the physical data records would be stored in the file system for the computer, such as that represented by the block 40 (typically a disk drive device), or alternatively, in a database . However, the logical data records for each file would be separately retrievable. Alternatively, the logical data records could also be stored on several different database systems or data bases at one or more files. For example, the XML DTD file could be stored on database system while the ID code files could be stored on a different database or file system.

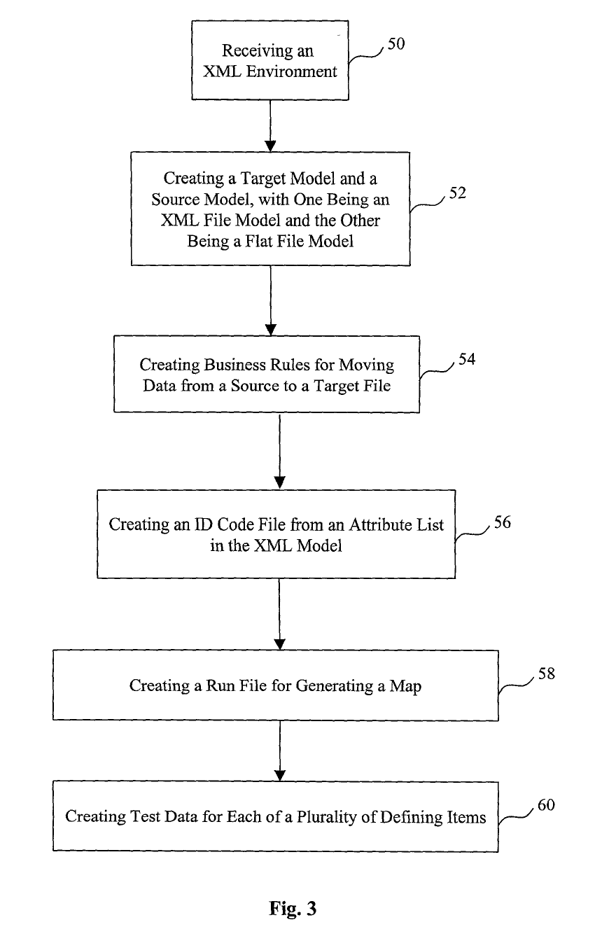

FIG. 3 is a flowchart showing the process steps of the programming structure used by the e-commerce data processing system 15 or the computer configuration at one or more of the trading partners computer systems. The invention is based on the premise that an XML file of some type is received, and it is desired to create an XML map for transforming the document represented for use by another trading partner that uses a different format, and in a flat file or data base form. Accordingly, the first step in the process is to obtain or otherwise receive an XML environment (to be defined below) in block 50. The execution then moves to block 52, wherein a target model and a source model are created and stored, for example, but not by way of limitation, in the source model file 48 and the target model file 49 in the computer storage 40, with one of these models being an XML file model and the other being a flat file or data base model. The operations to create these models will be set forth in detail below.

The execution then moves to block 54 wherein a set of business rules are created for moving data from a source file to a target file for a plurality of defining elements. These created business rules may be stored, by way of example but not by way of limitation, in the business rules file 45 in the storage 40. In a preferred embodiment, a business rule will be created for each of the defining elements in the source model. Note that a defining element is an XML element that can be mapped, i.e., it can have metadata associated therewith.

The execution then moves to block 56 wherein an ID code file is created using one or more attribute lists in the XML file. Again, the ID code file may be stored, by way of example but not by way of limitation, in the ID code file 46 in the storage 40. Then the execution moves to block 58 wherein a run file is created. As noted above, by way of example, this run file may be stored in the run file 47 in the storage 40. The run file contains the file names that are accessed in order to create the desired map.

Finally, the execution moves to block 60, wherein test data is created for a plurality of the elements based on the structure of the source model and the properties of the defining elements in the source model. The test data may be stored, by way of example but not by way of limitation, in the test data file 43 in the storage 40.

Referring in more detail to FIG. 3, a client in block 50 can download an XML DTD (an XML document type definition), XML Schema (including the document type definition and regular expressions), or an XML message (which follows the format of an XML DTD or XML schema) from a website such as OASIS, or from any other appropriate source. These three sources of XML are referred to by the term “XML environment,” which is intended to encompass all three. The XML auto-generator system shown in FIG. 2, using either this XML DTD, XML Schema or XML message, will automatically create a fully functional inbound (meaning the received XML file is converted to a flat file or a data base in the context of a user receiving an incoming communication) or outbound (meaning that an XML file will be converted to a flat file or data base in the context of sending a communication out to a third party) map, including one-to-one business rule mapping, sample data, run file, a source model, and a target model. The user could then use that working map as is, or more likely, use the working map as a template to customize the map to more closely meet its own internal application interface file requirements.

This process is summarized as follows:,

1. The input will be:

1.1. XML DTD, an XML Schema or an XML Message. The term “XML environment” is intended to encompass these three XML inputs.

2. Output will be:

2.1. A Complete Map:

2.1.1. A model of the XML structure as defined by the XML DTD, XML Schema or XML message. This model will be an XML data type. This could be either a Source or Target model in AI terms.

2.1.2. A model of the XML structure also defined by the XML DTD, XML Schema or XML message. This model will be a flat file or data base data type. This could be either a Source or Target model in AI terms.

2.1.3. Automatically generate the business rules that would be used to build a one-to-one map from the elements of the source data type structure to the elements of the target data type structure.

2.2. Test Data:

2.2.1. The XML Generator will also create test data based on the structure of the XML DTD, XML Schema or XML message.

2.2.2. The test data may be either of the XML data type or the flat file or data base type.

2.3. Run File:

2.3.1. The XML generator will create a complete Map Component File (xxx.ATT) including a Run file (xxx.RUN). The map will be user run-able immediately, if the user selected a source model, target model, business rules, and sample data creation.

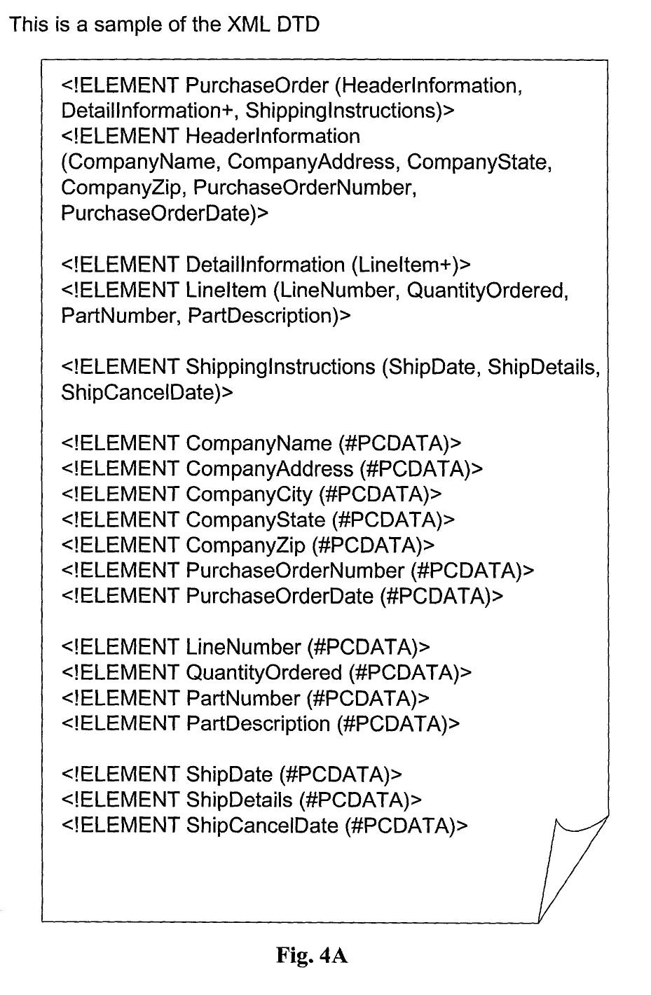

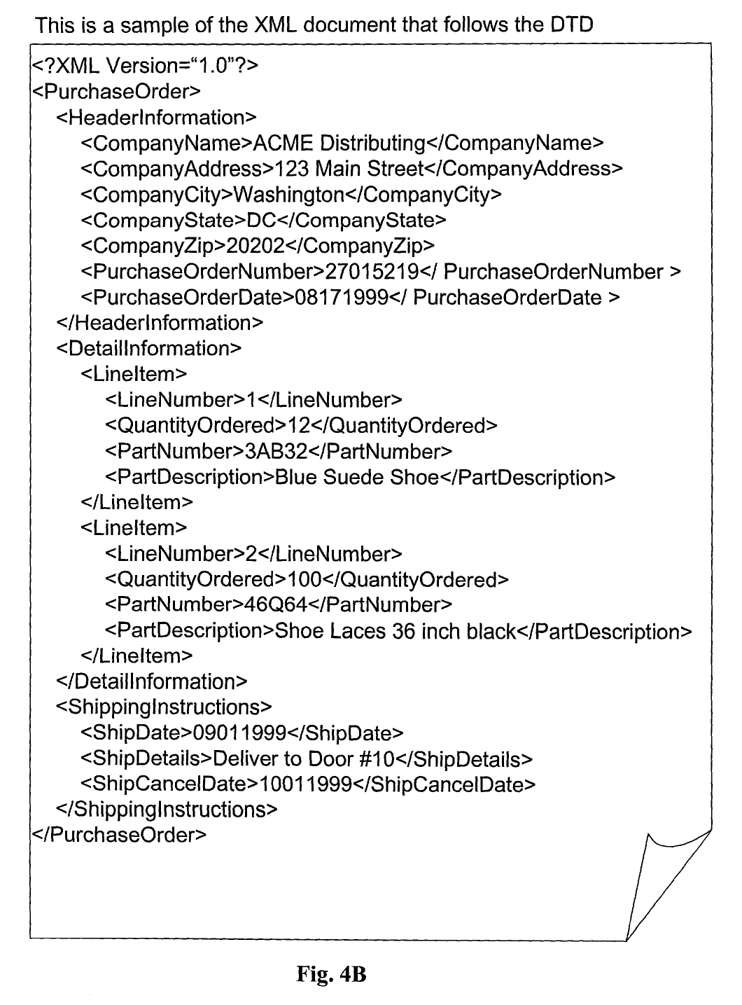

More details for this process are provided below. Referring now to FIG. 4A, there is shown an example XML DTD input for the generation process. As noted above, the XML input can be an XML DTD, XML Schema, or an XML message. The XML DTD, XML Schema, or XML message contains the information necessary to generate the various output files. An XML document that follows the XML DTD of FIG. 4A is shown in FIG. 4B.

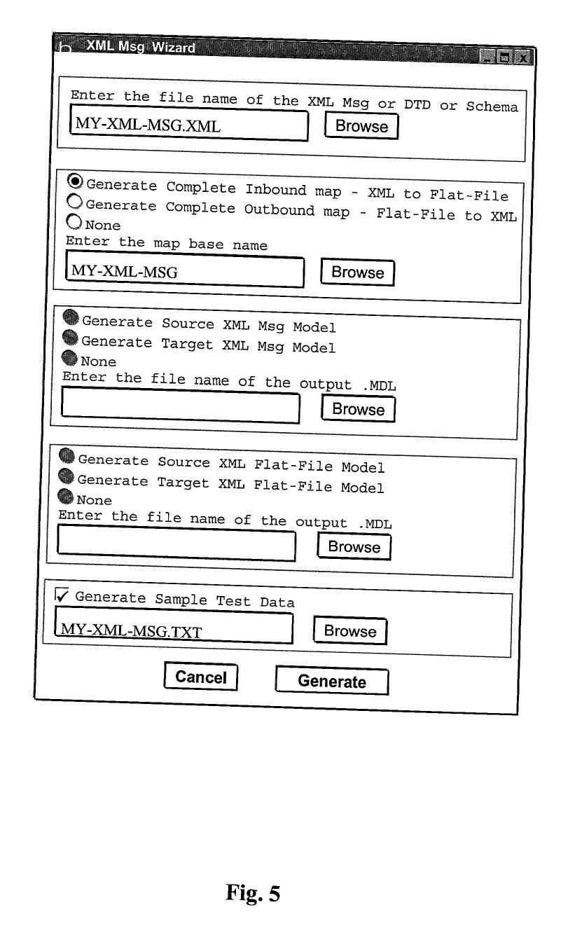

A process dialog box for the user is represented in FIG. 5. Note that the dialog box in the figure contains simple to understand prompts to the user to provide selection options for the process. The input file name is placed into the data entry area of the process dialog box interface. User controls are shown in the dialog box of FIG. 5 and include controls, that may be implemented in a standard fashion, to turn on or turn off or select the following items:

The user will be able to select if they want sample data to be generated.

The user will be able to select if they want a source or target model generated as the XML data type model.

The user will be able to select if they want a source or target model generated as the XML flat file or data base model.

The user will be able to select if they want business rules generated automatically or not. The default is to automatically generate the source model, target model, business rules, and sample data.

Note that the user interface of FIG. 5 presented here is solely for illustration purposes to help communicate what the process is. The user interface may however look differently than is depicted in this example. The user interface collects the inputs from the user and launches the process based on the user selections and user entries.

Depending on the user selections, the process will create a source and a target model, business rules, etc. as follows:

If the user selected Create Complete Inbound Map (Inbound means that the user is receiving an incoming XML file which is to be converted to a flat file) in the interface of FIG. 5, then the process would generate:

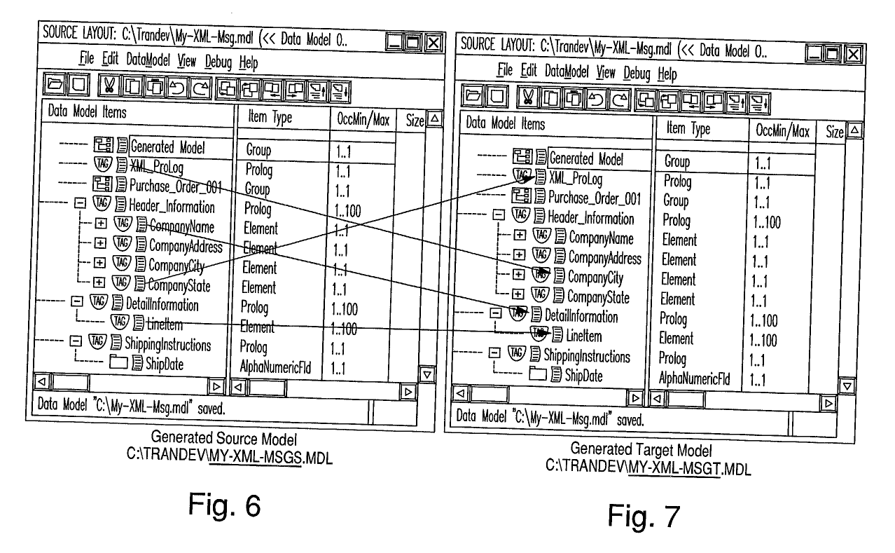

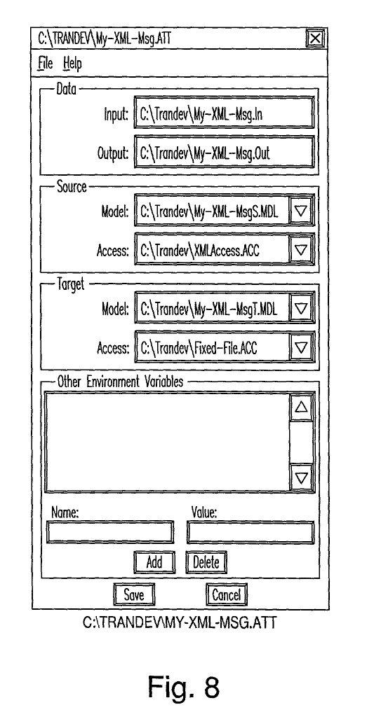

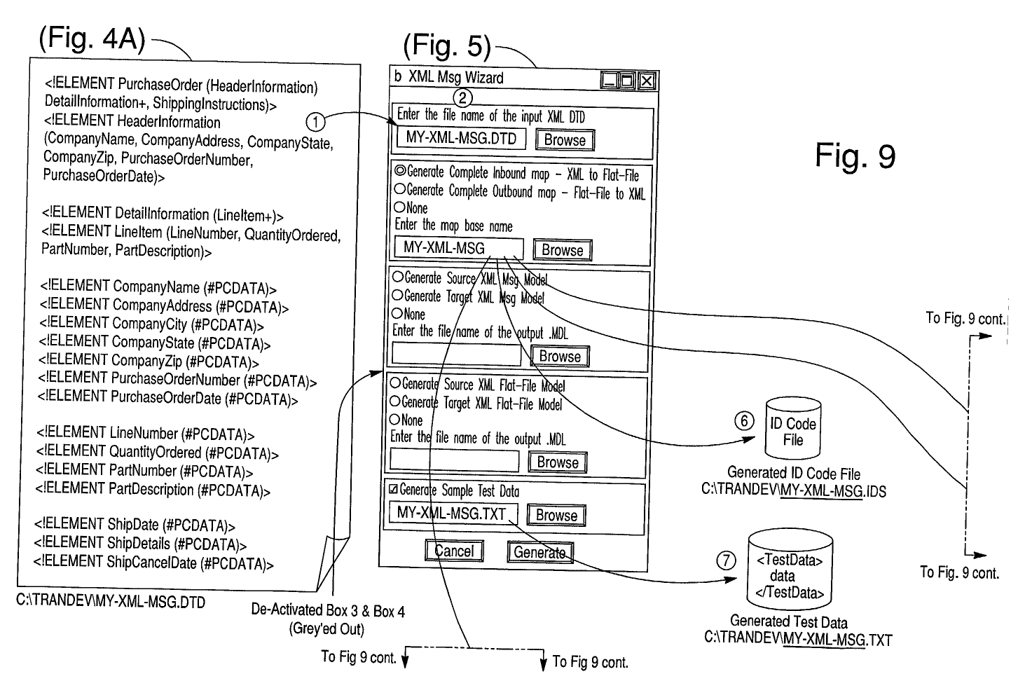

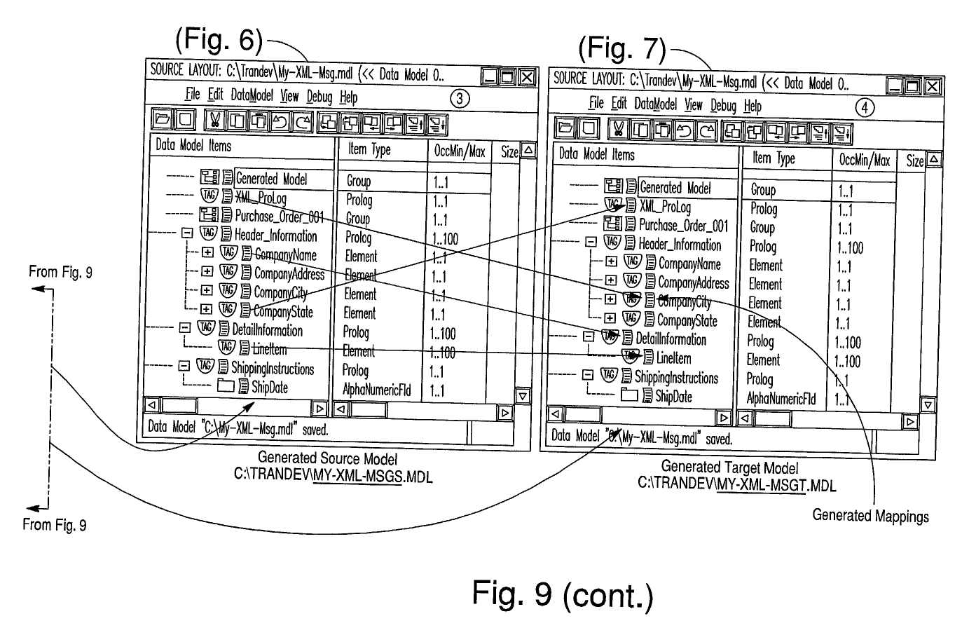

A Source XML model, of the type shown in FIG. 6 which, in a preferred embodiment, is created using the following rules of creation:

The XML model is a variable length representation of the XML file.

An Element that does not have children in the XML file would result in one record in the XML model.

Elements that have children (<Name>in the example below), become tags, and elements that do not have children are Defining items within the Tags. The parent element becomes the Tag. The children elements become the Defining Items within the record.

In the example,

<Name>

<First Name>
<Middle Name>
<Last Name>,

<Name> is the Tag and is a parent, and the elements <First Name>, <
Middle Name>, and <Last Name> are the children and are Defining items.

Elements that repeat become Tags with multiple occurrences.

Elements with the ?, question mark, are given properties of “optional”. In other words the element marked with ? can exist in the XML message but does not have to. If the element exists, it can only occur once, not multiple times. This is called optional.

Elements with the +, plus sign, are given properties of “mandatory”. In other words the element marked with + must have at least one occurrence in the XML message. These elements can have multiple occurrences with no upper limit, but no less than 1 occurrence. This is called mandatory.

Elements with the *, asterisk, are given properties of “optional”. In other words, the element marked with * may have zero or more occurrences. These elements can have multiple occurrences with no upper limit and no lower limit. This is optional.

Since the XML DTD, and XML message do not contain any data type properties, all data fields will be created as alphanumeric fields. Since the XML schema does have data type properties, those properties specified in the XML schema will be used to populate the data model item properties in the source or target data models.

Since there are no data type properties in the XML DTD and XML message, the min & max length of the data will be defined as between 0 and 4096. The actual length of the data will determine the physical output.

If the source model is an XML model, then a Target Flat-file model of the type shown in FIG. 7 is created using the following rules:

The Flat-file model is a fixed length representation of the normally variable length XML file.

Therefore one Element (or Tag) that does not have children in the XML file would result in one record in the flat-file model.

Elements that have children become tags, and elements that do not have children are Defining items within the Tags. The parent element becomes the Tag. The children elements become the Defining Items within the record.

Elements that repeat become records with multiple occurrences.

Elements with the ?, question mark, are given properties of “optional”. In other words the element marked with ? can exist in the XML message but does not have to. If the element exists, it can only occur once, not multiple times. This is called optional.

Elements with the +, plus sign, are given properties of “mandatory”. In other words the element marked with + must have at least one occurrence in the XML message. These elements can have multiple occurrences with no upper limit, but no less than 1 occurrence. This is called mandatory.

Elements with the *, asterisk, are given properties of “optional”. In other words the element marked with * may have zero or more occurrences. These elements can have multiple occurrences with no upper limit and no lower limit. This is called optional.

The Attributes of each XML element are detected and extracted and an ID Code file 46 (see FIG. 2) is built for each element with attributes. Note that the attributes describe the valid values for the given element.

Since the XML DTD, and XML message do not contain any data type properties, all data fields will be created as alphanumeric fields. Since the XML schema does have data type properties, those properties specified in the XML schema will be used to populate the data model item properties in the source or target data models.

Since there are no properties in the XML DTD or XML message, the min & Max length of the data will be defined as the length of the tagname. The user will then modify the properties to match the actual data. For example, a tagname of TAGNAME would have a min/max length of 7 since there are 7 letters in the word TAGNAME.

In operation, since an Inbound situation means that the user started with a source XML file, then the source side will execute first. The execution will start at the beginning or top of the source XML input and detect each defining item. It will create a rule on the source XML side to drop the defining item into a designated bucket (variable item). Then it will create a rule for the target side to take the defining item from the designated bucket and drop it at a destination location in the target flat file or data base model. Typically the target flat file or data base model will use the same element order as the source XML model, so that the first element in the Source XML model will be located as the first element in the target flat file or data base model. However, this ordering can be modified to take any convenient pattern that may be preset by the user. Note that the target model may be created at the same time or after the creation of the source model.

Accordingly, it can be seen that in a preferred embodiment, the target flat file or data base model will be created that has elements with like names to the XML DTD, XML schema, or XML message used to create the source XML model.

Thus, one-to-one business rules have been created that will map one source data model item (such as an element, or group, or tag, or a record, by way of example) to the corresponding target data model item. This is represented by the criss-cross lines between FIG. 6 and FIG. 7. Note that special rules for specific elements may also be inserted. For example, a target structure, such as an invoice, may only be able to accept data in a certain format (for example, the target structure may only be able to read numbers, so that all letters in the invoice designator must be stripped off or replaced with a predetermined number). Such special rules could be created by the user after the creation of the respective source or target model, by simply clicking on a rule builder icon in the model layout editor of FIG. 6 for the source model and FIG. 7 for the target model. Building a rule means adding logic to the model to accomplished the desired operation. As can be seen from a review of FIG. 6 and FIG. 7, there is a separate rule builder icon adjacent to each of a plurality of different data model items. By way of example, there is a rule builder icon adjacent to the INVOICE NUMBER item. Clicking on this icon would open a window to create a rule for the INVOICE NUMBER item. Desired logic parameters could be added into the window. Clicking the rule builder icon again would insert this rule so that it now applies to all instances of the INVOICE NUMBER data model item.

If the user selected Create Complete Outbound Map (“Outbound” means converting a flat file or data base to an XML file) in the user interface of FIG. 5, then the process would generate:

A Source Flat-file model source data base model using the following rules:

The Flat-file model is a fixed length representation of the normally variable length XML file.

Therefore one Element that does not have children in the XML file would result in one record in the flat-file model.

Elements that have children become tags, and elements that do not have children are Defining items within the Tags. The parent element becomes the Tag. The children elements become the Defining Items within the record.

Elements that repeat become records with multiple occurrences.

Elements with the ?, question mark, are given properties of “optional”. In other words the element marked with ? can exist in the XML message but does not have to. If the element exists, it can only occur once, not multiple times. This is called optional.

Elements with the +, plus sign, are given properties of “mandatory”. In other words the element marked with + must have at least one occurrence in the XML message. These elements can have multiple occurrences with no upper limit, but no less than 1 occurrence. This is called mandatory.

Elements with the *, asterisk, are given properties of “optional”. In other words, the element marked with * may have zero or more occurrences. These elements can have multiple occurrences with no upper limit and no lower limit. This is called optional.

Since the XML DTD, and XML message do not contain any data type properties, all data fields will be created as alphanumeric fields. Since the XML schema does have data type properties, those properties specified in the XML schema will be used to populate the data model item properties in the source or target data models.

Since there are no properties in the XML DTD or XML message, the Min & Max length of the data will be defined as the length of the tagname. The user will then modify the properties to match the actual data. For example, a tagname of TAGNAME would have a min/max length of 7 since there are 7 letters in the word TAGNAME.

For a Target XML model

The XML model is a variable length representation of the XML file.

One Element that does not have children in the XML file would result in one record in the XML model.

Elements that have children become tags, and elements that do not have children are Defining items within the Tags. The parent element becomes the Tag. The children elements become the Defining Items within the record.

Elements that repeat become Tags with multiple occurrences.

Elements with the ?, question mark, are given properties of “optional”. In other words the element marked with ? can exist in the XML message but does not have to. If the element exists, it can only occur once, not multiple times. This is called optional.

Elements with the +, plus sign, are given properties of “mandatory”. In other words the element marked with + must have at least one occurrence in the XML message. These elements can have multiple occurrences with no upper limit, but no less than 1 occurrence. This is called mandatory.

Elements with the *, asterisk, are given properties of “optional”. In other words the element marked with * may have zero or more occurrences. These elements can have multiple occurrences with no upper limit and no lower limit. This is optional.

The Attributes of each XML element are extracted and an ID Code file is built for each element with attributes.

Since the XML DTD, and XML message do not contain any data type properties, all data fields will be created as alphanumeric fields. Since the XML schema does have data type properties, those properties specified in the XML schema will be used to populate the data model item properties in the source or target data models.

Additionally since there are no properties in the XML DTD or XML message, the min & max length of the data will be defined as between 0 and 4096. The actual length of the data will determine the physical output.

In operation, since an Outbound (flat file to XML file) situation means that the process starts with a flat file or data base, then the source side will execute first. The execution will start at the beginning or top of the source input and detect each defining item (no children). It will create a rule on the source side to drop the defining item into a designated bucket. Then it will create a rule for the target side to take the defining item from the designated bucket and drop it at a destination location in the target XML model. Typically the target XML model will use the same element order as the source flat file, so that the first element in the Source flat file or data base will be located as the first element in the target XML model. However, this ordering can be modified to take any convenient pattern that may be preset by the user. Note that the target XML model may be created at the same time or after the creation of the source model.

Thus, one-to-one business rules have been created that will map one source item to the corresponding target item. This is represented by the criss-cross lines between FIG. 6 and FIG. 7.

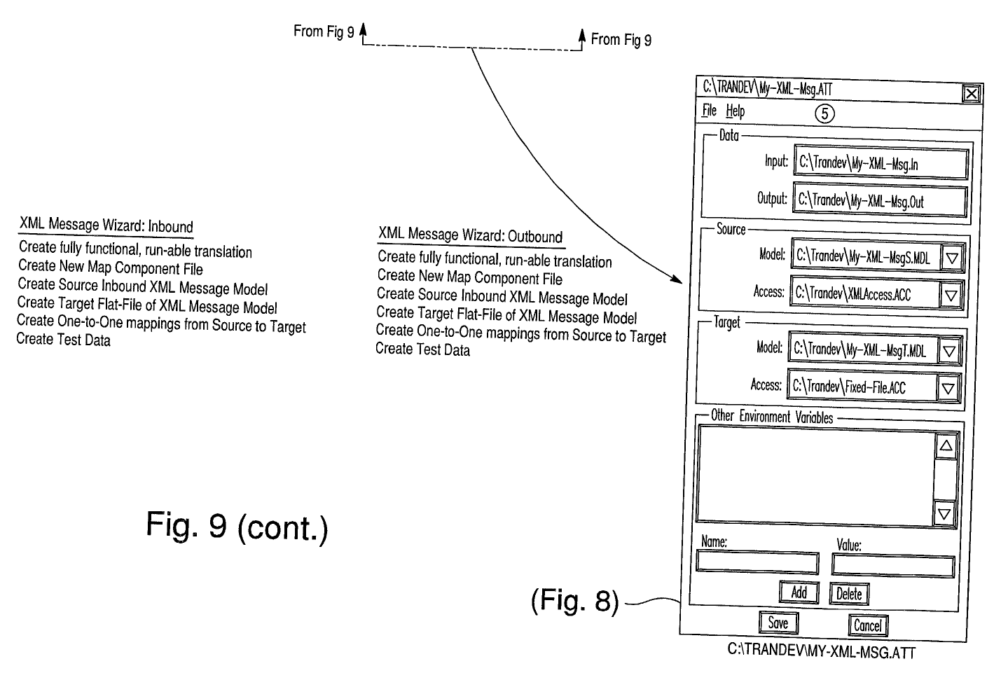

The run file is then generated. The visual identified as FIG. 8 is the visual representation of the contents of the run file. The run file as viewed in a data editor would look like this:

| ;; Sample RosettaNet XML Inbound Map Component File | |
|---|---|
| ;; | OTRNASI.att |
| ;; | ver 3.1 |
| ;; | ---------- |

OUTPUT_FILE = “(OUTPUTFILENAME)”
S_MODEL = “OTRNASIS.mdl” [the Source Model file]
S_ACCESS = “OTXMLS.acc” [code telling the Source Model,

on a character-by-character basis, how to read source data and its
meaning]

T_MODEL = “OTRNASIT.mdl” [Target Model file]

T_ACCESS = “OTFixed.acc” [code telling the Target Model, on a
character-by-character basis, how to read the target data and its meaning]

It should be understood that when the models are created, the Attributes (if any) of each XML element are extracted from the XML DTD or XML Schema, and an ID Code file 46 is built for each element with an attribute or an attribute list. By way of example, the attributes for the element <month> might be Jan, Feb, Mar, etc. After the IDs in the ID code file are built, the file is available to be imported into a Trade Guide, trading partner administration component. Note that an XML message does not contain a list of attributes, therefore if an XML message is used as the input, then the IDs file 46 will not be created.

After the source and target models have been created, then test data is created. Because this is an outbound process, flat file test data is created. The generated source model will be used as the input to this portion of the process, because it contains more metadata, in terms of data type properties than does the XML DTD, XML Schema or XML message. For example, the source model for an invoice might contain metadata for an element including how many times the element repeats, the maximum size of the data in terms of positions, i.e., 5 positions long, for example, the data type, i.e., numeric for example. Test data would then be created fitting those parameters. The data might not be meaningful to the user, but it would accurately test the parameters for the element in question.

If the user selected Create Complete Inbound Map (an XML input is received and must be converted to a flat file) via the user interface in FIG. 4, then the process would generate:

A Source XML model (Fig, 6).

A Target Flat-file model (FIG. 7).

The Source XML model of FIG. 6 would be used as the input to the test data generation process, because the Source model contains more data type properties information than does the XML DTD, XML Schema or XML message.

If an XML message is used as the input in block 50 of FIG. 3, then there would be no test data generated because the user already has the XML message to use as test data. The XML message typically is better quality test data from the trading partner than can be generated based on default properties.

The test data would be generated by generating an XML message. The test generation process would take the Source XML Model and search for a first defining item (the lowest level of a definition, such as <First Name> in the previous example). The test generation process then searches/detects the properties of the defining item in the model and automatically creates data that matches the detected properties and structure of the defining element. By way of example, for a defining item of <First Name>, having the properties set forth in the Source Model for that defining item of data type=alpha, random characters would be created that match these properties and structure, i.e., the test data for <First Name> could be “aaaaa.” Every defining item in the Source Model would be detected in this manner, and test data generated as described above. Note that the structure for the test data would be as follows:

The XML message with the test data would contain a prolog (tells the browser or other process what encoding scheme and/or character set is being used).

The XML message would also contain a preamble (specifies the XML DTD or XML schema being used).

The XML message would contain the Tags as defined in the XML DTD or XML Schema of the XML input.

The Tags would be in the proper sequence as defined in the XML DTD or XML Schema from the XML input.

The data between the start and end tags would be the tagname itself. For example: the XML DTD or XML Schema defines an !ELEMENT Month, the test data generated would look like <Month >Month </Month >.

If an attribute list is specified, then the first entry in the attribute list will be used as the test data instead of the tagname. For example: if the following Attribute list is specified in the DTD or Schema for the element <Month >:

<?XML Version = “1.0”?> [this is the Prolog that defines the
encoding schema and/or character set]
<!DOCTYPE account SYSTEM “account.dtd” [this is the
Preamble setting out the specific XML DTD]
!ELEMENT account (#PCDATA*>
!ATTLIST Month

Name
(Jan|Feb|Mar|Apr|May|Jun|Jul|Aug|Sep|Oct|Nov|Dec
) #REQUIRED>

]>

In this example the vertical bars “|” mean “or”. Therefore this reads Jan or Feb or Mar and so on.

In this example the #REQUIRED means that this value is required. It is not optional.

When an attribute list is used, then values other than those stated in the list are invalid and would fail when checked in a Validating Parser such as AI™.

In this example, the element Month is Required and it has the values specified for the Name attribute. Therefore if the attribute list is provided, then the auto-generation process will select the first attribute from the list as the test data value for that element. Therefore the test data value would be <Month >Jan </Month >

Further if a Default attribute value is specified by using the default option in the attribute list, then the test data value for that element should not be given the first value in the list but rather it should be given the Default value from the XML DTD or XML schema attribute list default value.

All elements defined in the XML DTD, XML Schema, even those that are defined as optional will be generated in the test data.

Elements that are defined as multiple occurrences, by way of example, will be given two occurrences in the output test data.

Alternatively, if the user selected Create Complete Outbound Map (converting a flat file or data base to an XML environment) on the user interface of FIG. 5, then the process would generate:

A Source Flat-file model.

A Target XML model.

The Source Flat-file model would be used as the input to the test data generation process, because the Source model contains more data type properties information than does the XML DTD, XML Schema or XML message.

If an XML message is used as the input in block 50 of FIG. 3, then test data would still be generated.

The test data would be generated by generating a flat file or data base that contains the same fields as the input XML environment. The test generation process would take the source Model and search for a first defining item (the lowest level of a definition, such as First Name in the previous example). The test generation process then searches/detects the properties of the defining item in the model and automatically creates data that matches the detected properties and structure of the defining element. By way of example, for a defining item of First Name, having the properties set forth in the Source Model for that defining item of character type=alpha, random characters could be created or a single character could be used that match these properties and structure, i.e., the test data for First Name could be “abcde. ” Every defining item in the Source Model would be detected in this manner, and test data generated as described above. Note that the structure for the test data would be as follows:.

The flat file test data or data base test data would contain the records and fields as defined in the source model.

The records would be in the proper sequence as defined in the source model.

All defining items defined in the source model, even those that are defined as optional, will be generated in the test data.

Elements that are defined as multiple occurrences in the source model, may, for example, be given two occurrences in the output test data.

It should be noted that the step of simultaneously displaying the source model and the target model on a single display may be readily accomplished using the Workbench component of the “Application Integrator” software product licensed by GE Information Systems. Likewise, the step of moving at least one element in one of the source and target models to a different location within that one model may readily be accomplished by the aforementioned Workbench component.

It should be noted that the map generation process and the various map generation run files may be stored at the user's computer, or they may be accessed over a network of any convenient type. Such network access may be set in the context of a variety of different environments.

For purposes of the specification and the claims, the designation “XML” is to be interpreted to cover XML, logical extensions of XML, and other similar extensible markup languages.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

1. A method for automatically generating an XML map comprising the steps of:
receiving an XML environment;
creating a target model and a source model in accordance with predetermined rules, with one of said models being an XML model and the other of said models being a flat file or data base model;
creating business rules for moving data from a source file to a target file for a plurality of defining items in the source model;
creating a run file with file names for generating said map.

2. The method as defined in claim 1, further comprising the step of:
creating test data for each of said plurality of defining items.

3. The method as defined in claim 2, wherein said test data is created based on the structure of the source model and the properties of the defining elements from said source model.

4. The method as defined in claim 1, further comprising the step of creating at least one ID code file from an attribute list in said XML environment.

5. The method as defined in claim 1, wherein said creating business rules step comprises creating a business rule for all defining items in said source model.

6. The method as defined in claim 1, further comprising the step of simultaneously displaying said source model and said target model on a single display.

7. The method as defined in claim 5, further comprising the step of moving at least one element in one of the source and target models to a different location within that one model.

8. The method as defined in claim 6, wherein said moving step comprises drag and dropping said element over a desired location within the one model.

9. The method as defined in claim 1, further comprising the step of manually creating a business rule by drag and dropping an element in one of said source and target models to an element in the other of said source and target models.

10. The method as defined in claim 1, wherein the run file includes a source file, a source model, a target file, a target model, a source access file, and a target access file.

11. The method as defined in claim 1, wherein the XML environment is one of an XML DTD, and XML schema, and an XML message.

12. The method as defined in claim 1, comprising the step of providing a user interface to permit the selection of an inbound or an outbound map.

13. The method as defined in claim 12, wherein the provided user interface permits the addition of specific rules for controlling the transfer of data between a source element and a target element.

14. The method as defined in claim 1, wherein the created source and target models use substantially the names or elements or defining items of the XML environment.

15. The method as defined in claim 14, wherein the defining item names are in the same order in the created source and target models immediately after the model creation step.

16. The method as defined in claim 2, wherein the test data is an XML message.

17. The method as defined in claim 2, wherein the test data is a flat file or a data base.

18. The method as defined in claim 17, wherein the test data is generated based on information in the source model.

19. The method as defined in claim 18, wherein the XML message contains a Prolog and a Preamble.

20. The method as defined in claim 18, wherein the XML message comprises, if said XML environment is an XML DTD or an XML schema, all defining items or elements in the XML DTD or the XML schema.

21. The method as defined in claim 18, wherein each piece of test data for the defining item or element is created to be consistent with the properties of the defining item and using attributes from an attribute list for that defining item, if such an attribute list is included in the XML DTD or XML schema.

22. The method as defined in claim 20, wherein the test data for the defining item/element is in the same sequence as defined in the XML environment.

23. The method as defined in claim 18, wherein the generated test data for defining item is a tag name for the defining element.

24. A system for automatically generating an XML map comprising:
a first component to receive an XML environment;
a second component to create a target model and a source model in accordance with predetermined rules, with one of said models being an XML model and the other of said models being a flat file or data base model;
a third component to create business rules for moving data from a source file to a target file for a plurality of defining items in the source model;
a fourth component to create a run file with file names for generating said map.

25. A program product for automatically generating an XML map comprising the following machine readable program code:
first code for receiving an XML environment;
second code for creating a target model and a source model in accordance with predetermined rules, with one of said models being an XML model and the other of said models being a flat file or data base model;
third code for creating business rules for moving data from a source file to a target file for a plurality of defining items in the source model;
fourth code for creating a run file with file names for generating said map.
